(19) United States
(12) Patent Application Publication
(10) Pub. No.: US 2025/0241287 A1
(43) Pub. Date: Jul. 31, 2025

(54) SYSTEM AND METHOD FOR AN AGRICULTURAL APPLICATOR

(71) Applicant: CNH Industrial America LLC, New Holland, PA (US)

(72) Inventors: Roy A. Bittner, Reedsville, WI (US); Blaine Schwalbe, Valders, WI (US); Peter Hobson, Manitowoc, WI (US)

(21) Appl. No.: 18/428,117

(22) Filed: Jan. 31, 2024

(51) Int. Cl. A01M 7/00; F16F 7/12

(52) U.S. Cl. CPC A01M 7/0078; F16F 7/12

(57) ABSTRACT

An agricultural system may include a boom assembly including an inner boom section having an inner section frame and a breakaway boom section having a breakaway section frame. A hinge assembly can be configured to guide the movement of the breakaway boom section relative to the inner boom section. The hinge assembly may include an inner bracket operably coupled with the inner boom section and a mounting plate, an outer bracket operably coupled with the breakaway section frame, a hinge pin operably coupled with the outer bracket, and a bore operably coupled with the mounting plate and surrounding the hinge pin. A damper system may be operably coupled with the inner bracket and the outer bracket. At least a portion of the inner bracket is positioned above the damper system.

### FIELD

The present disclosure generally relates to agricultural machines and, more particularly, to systems and methods for a boom assembly of the agricultural machine.

### BACKGROUND

Various types of machines utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, agricultural product, fungicide, a pesticide, or another product).

The applicators may be pulled as an implement or self-propelled and may include a tank, a pump, a boom assembly, and a plurality of nozzles carried by the boom assembly at spaced locations. The boom assembly may include a pair of boom arms, with each boom arm extending to either side of the applicator when in an unfolded state. Each boom arm may include multiple boom sections, each with a number of spray nozzles (also sometimes referred to as spray tips).

During the operation of the agricultural machine, however, in some instances, an outer portion of the boom assembly may contact an object. Accordingly, an improved system and method for a breakaway boom section would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system that includes a boom assembly including an inner boom section having an inner section frame and a breakaway boom section having a breakaway section frame. A hinge assembly is configured to guide movement of the breakaway boom section relative to the inner boom section. The hinge assembly includes an inner bracket operably coupled with the inner boom section and a mounting plate, an outer bracket operably coupled with the breakaway section frame, a hinge pin operably coupled with the outer bracket, and a bore operably coupled with the mounting plate and surrounding the hinge pin. A damper system is operably coupled with the inner bracket and the outer bracket. At least a portion of the inner bracket is positioned above the damper system.

In some aspects, the present subject matter is directed to a method for an agricultural application operation that includes rotating, with a hinge assembly, a breakaway boom section relative to an inner boom section through one or more hinge joints. The method also includes returning, with a damper system, the breakaway boom section to a default position. Lastly, the method includes retaining, with a retainment assembly, one or more conduits at least partially above the damper system as the breakaway boom section is rotated relative to the inner boom section.

In some aspects, the present subject matter is directed to an agricultural system that includes a boom assembly including an inner boom section and a breakaway boom section. A hinge assembly is configured to guide movement of the breakaway boom section relative to the inner boom section. A damper system is operably coupled with the inner boom section and the breakaway boom section. A retainment assembly is configured to route one or more conduits vertically above at least a portion of the damper system.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural machine in accordance with aspects of the present subject matter;

FIG. 2 illustrates a side view of the machine in accordance with aspects of the present subject matter;

FIG. 3 is a rear view of a boom assembly that may be operably coupled with the machine in accordance with aspects of the present subject matter;

FIG. 4 is an enhanced front perspective view of area IV of FIG. 3 illustrating a portion of the boom assembly in accordance with aspects of the present subject matter;

FIG. 5 is an enhanced rear perspective view of area IV of FIG. 3 illustrating a portion of the boom assembly in accordance with aspects of the present subject matter;

FIG. 6 is an enhanced top plan view of area VI of FIG. 3 illustrating a portion of the boom assembly in accordance with aspects of the present subject matter;

FIG. 7 is an enhanced rear perspective view of area IV of FIG. 3 illustrating a portion of the boom assembly in accordance with aspects of the present subject matter;

FIG. 8 is an enhanced rear view of area IV of FIG. 3 illustrating a portion of the boom assembly in accordance with aspects of the present subject matter; and

FIG. 9 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present subject matter is directed to an agricultural system that may include a boom assembly including an inner boom section having an inner section frame and a breakaway boom section having a breakaway section frame. A hinge assembly can be configured to guide the movement of the breakaway boom section relative to the inner boom section. The hinge assembly may include an inner bracket operably coupled with the inner boom section and a mounting plate, an outer bracket operably coupled with the breakaway section frame, a hinge pin operably coupled with the outer bracket, and a bore operably coupled with the mounting plate and surrounding the hinge pin.

A damper system may be operably coupled with the inner bracket and the outer bracket. At least a portion of the inner bracket is positioned above the damper system. The damper may be configured to control the force and the speed at which the damper resists movement of the breakaway boom section and/or moves the breakaway boom section to a default position once the breakaway boom section is deflected.

A sensor system may be operably coupled with the boom assembly and configured to generate data indicative of an operating condition of the machine, a condition of the field, an environmental condition, and/or any other condition. In various examples, the sensor system may generate the data through one or more sensors that may be mounted along the boom assembly. For instance, one or more sensors may be mounted on the inner boom section, and/or one or more sensors may be mounted on the breakaway boom section. One or more sensors may be mounted on any other portion of the boom assembly and/or the machine as well without departing from the scope of the present disclosure.

A retainment assembly may be operably coupled with the inner bracket and/or the outer bracket. In various examples, the retainment assembly may be configured to selectively retain one or more conduits with one or more retainers. The conduits may be configured as hoses for guiding an agricultural product to one or more nozzle assemblies along the boom assembly. Additionally or alternatively, the conduits may be configured to retain one or more cables, wires, or other devices that are configured to provide power, transmit data, and/or provide any other function for one or more components distributed along the boom assembly. In some instances, the retainment assembly may be configured to selectively route one or more conduits vertically above at least a portion of the damper system. Additionally or alternatively, the retainment assembly can retain the one or more conduits at least partially above the damper system as the breakaway boom section is rotated relative to the inner boom section. As such, the conduits may be generally free from contact with the hinge assembly and/or the damper system as the breakaway boom section is rotated relative to the inner boom section.

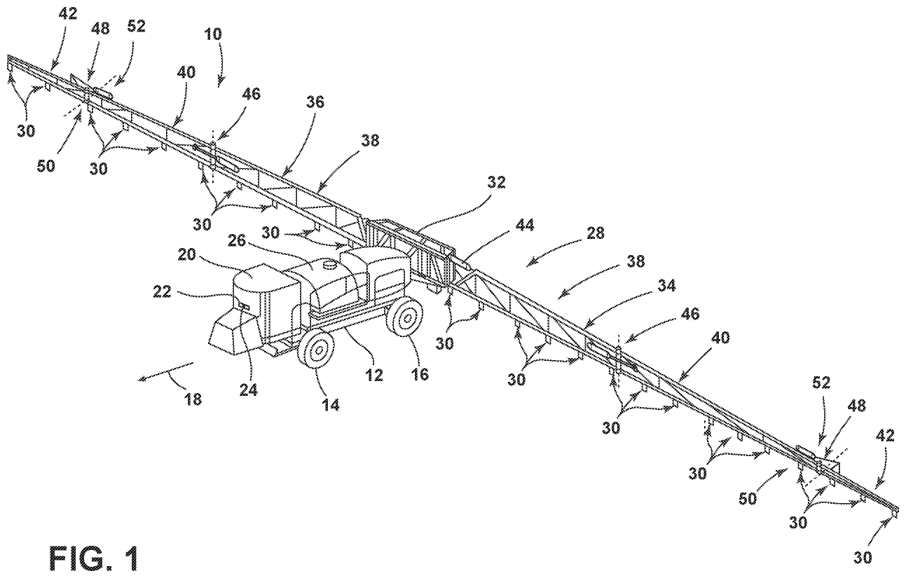

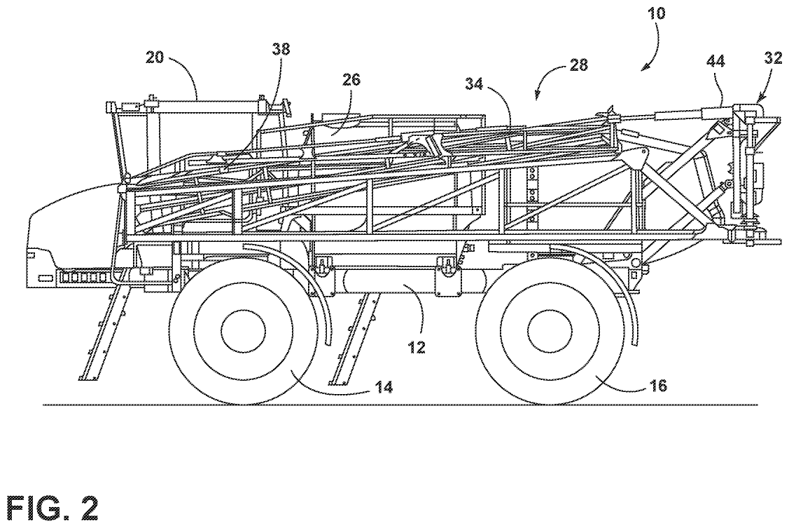

Referring now to FIGS. 1 and 2, a machine 10 is generally illustrated as a self-propelled agricultural applicator. However, in alternate embodiments, the machine 10 may be configured as any other suitable type of machine 10 configured to perform agricultural application operations, such as a tractor or other machine configured to haul or tow an application implement.

In various embodiments, the machine 10 may include a chassis 12 configured to support or couple to a plurality of components. For example, front and rear wheels 14, 16 may be coupled to the chassis 12. The wheels 14, 16 may be configured to support the machine 10 relative to a ground surface and move the machine 10 in a forward direction of travel as indicated by arrow 18 in FIG. 1 (the direction of forward travel may be parallel to a fore-aft direction) across a field or the ground surface. In this regard, the machine 10 may include a power plant, such as an engine, a motor, or a hybrid engine-motor combination, to move the machine 10 along a field.

The chassis 12 may also support a cab 20, or any other form of operator's station, which provides various control or input devices 22 (e.g., levers, pedals, control panels, buttons, and/or the like) for providing various notifications to an operator and/or permitting the operator to control the operation of the machine 10. For instance, as shown in FIG. 1, the machine 10 may include a human-machine interface (HMI) 24 for displaying messages and/or alerts to the operator and/or for allowing the operator to interface with the machine's controller through the one or more user input devices 22.

The chassis 12 may also support a tank 26 and a boom assembly 28 mounted to the chassis 12. The tank 26 is generally configured to store or hold an agricultural product, such as a pesticide, a fungicide, a rodenticide, a fertilizer, a nutrient, and/or the like. The agricultural product stored in the tank 26 may be dispensed onto the underlying ground surface (e.g., plants and/or soil) through one or more nozzle assemblies 30 mounted on the boom assembly 28.

As shown in FIGS. 1 and 2, the boom assembly 28 may include a boom frame 32 that supports first and second boom arms 34, 36 in a cantilevered nature. The first and second boom arms 34, 36 are generally movable between an operative or unfolded position (FIG. 1) and an inoperative or folded position (FIG. 2). When distributing the product, the first and/or second boom arm 34, 36 extends laterally outboard from the machine 10 to cover wide swaths of soil, as illustrated in FIG. 1. However, to facilitate transport, each boom arm 34, 36 of the boom assembly 28 may be independently folded fore or aft into the inoperative position, thereby reducing the overall width of the machine 10, or in some examples, the overall width of a towable implement when the applicator is configured to be towed behind the machine 10.

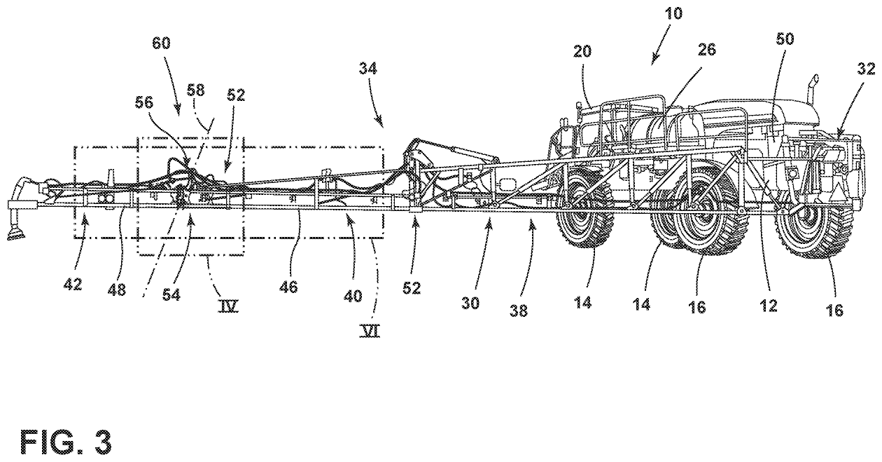

As shown in FIG. 3, each boom arm 34, 36 may include a number of sections. In the illustrated example, each boom arm 34, 36 includes a primary boom section 38, an outer boom section 40 (or inner boom section 40), and a breakaway boom section 42. In various examples, the primary boom section 38 may include a primary section frame 44, the outer boom section 40 may include an outer section frame 46, and/or the breakaway boom section 42 may include a breakaway section frame 48. In various examples, any boom section that is inboard of the breakaway boom section 42 may be generically referred to as an inner boom section.

In other examples, the boom arms 34, 36 may include more or less than two (2) sections. Inner end portions of the primary boom section 38 for each boom arm 34, 36 may be coupled to the boom frame 32 through a lift arm assembly 50. Hinge joints 52 may connect the outer end portions of the primary boom sections 38 with the inner end portions of the outer boom sections 40. In some instances, the hinge joints 52 can include one or more breakaway joints 54 may interconnect the outer end portions of the outer boom section 40 with the inner end portions of the breakaway boom sections 42. Each breakaway joint 54 may be configured to retain the breakaway boom sections 42 in an extended, default position, for example, with the breakaway boom section 42 extending from the outer boom section 40 or any other boom section. However, the breakaway joint 54 may be configured to allow the breakaway boom section 42 to move relative to the outer boom section 40 when contact is made with the breakaway boom section 42. In some examples, the breakaway joint 54 may include a hinge assembly 56 that guides the movement of the breakaway boom section 42 and may define a pivot axis 58 about which the breakaway boom section 42 pivots. The breakaway joint 54 may also include a damper system 60 that is positioned proximate to the breakaway joint 54.

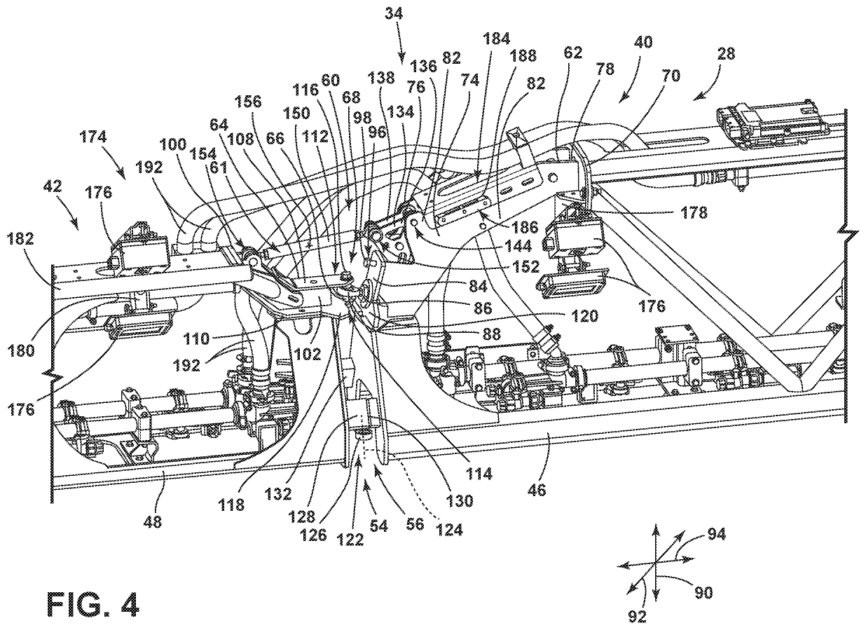

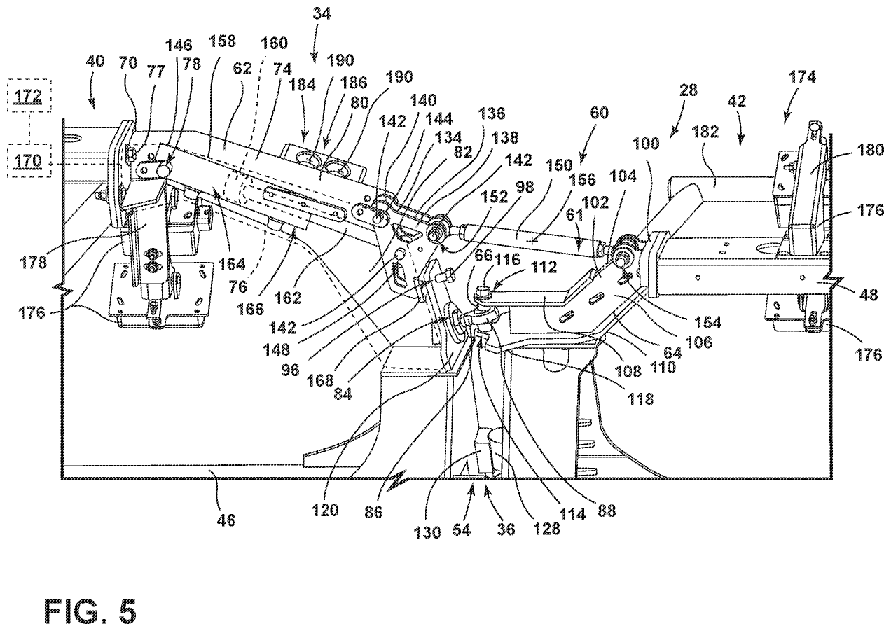

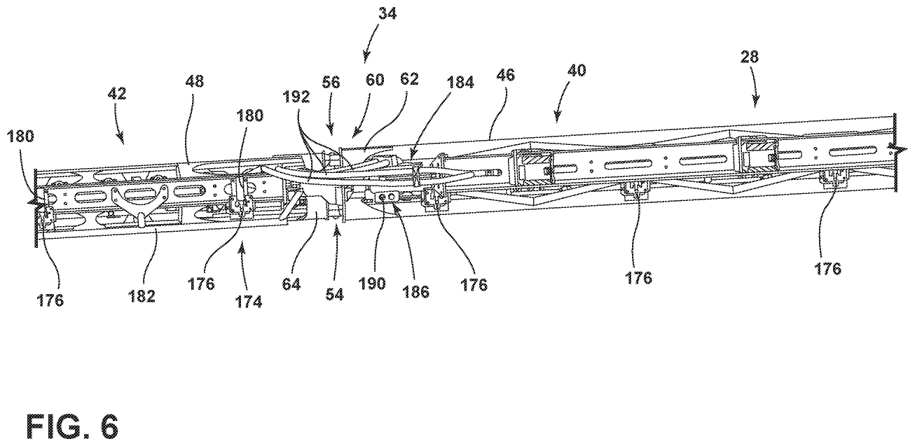

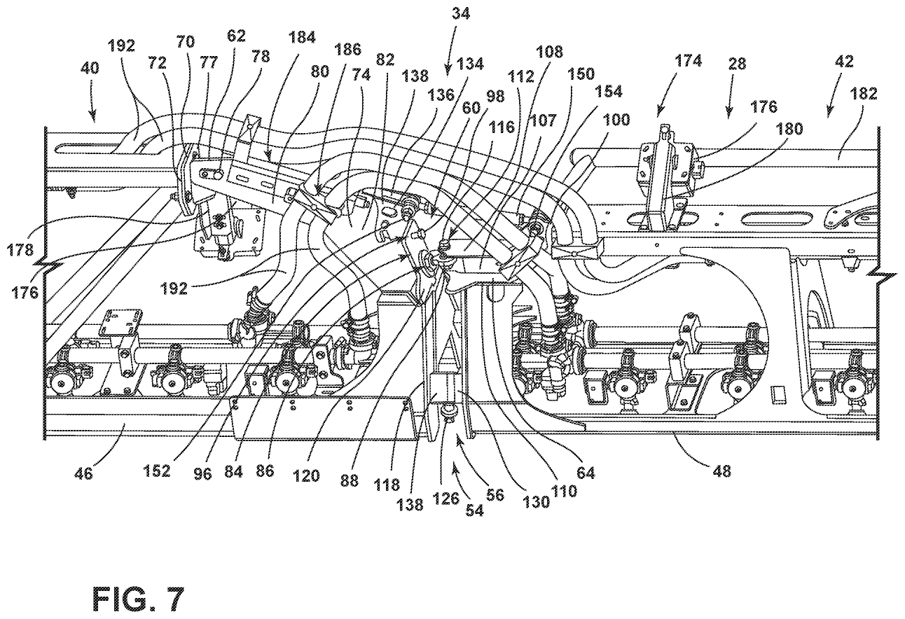

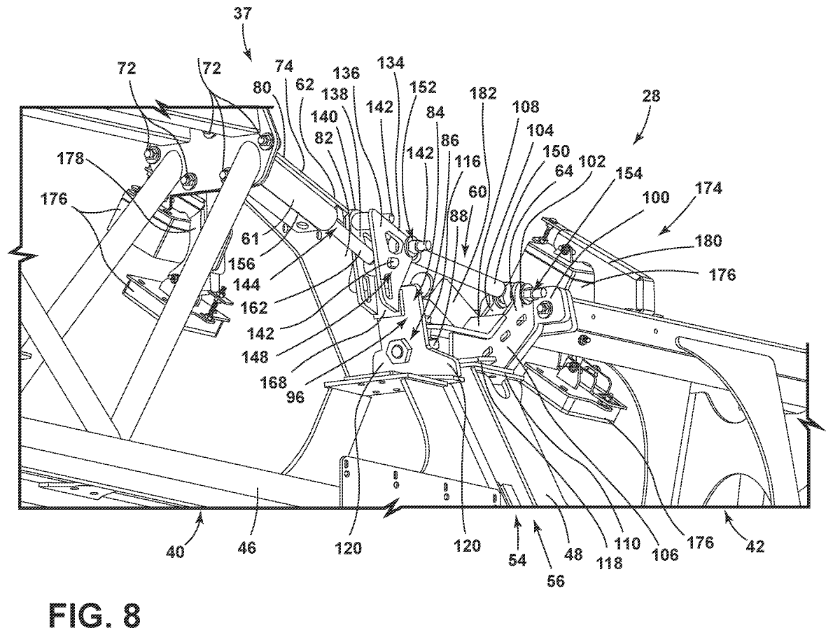

Referring now to FIGS. 4-8, in some examples, the hinge assembly 56 may include an inner bracket 62 connected to the outer end portion of the outer boom section 40 and an outer bracket 64 connected to the inner end portion of the breakaway boom section 42. A hinge pin 66 may connect the inner and outer brackets 62, 64 to each other and defines a first hinge joint 68 about which the breakaway boom section 42 pivots.

In some examples, the inner bracket 62 may include an attachment plate 70 that may be configured to operably couple with the inner boom section 40, such as through one or more fasteners 72, adhesives, weldments, and/or any other practicable device or method. The inner bracket 62 may also include a pair of walls 74, 76. Each of the walls 74, 76 may include a first region 78, a second region 80 that may be offset from the first region 78, and a third region 82 that may be offset from the second region 78.

The inner bracket 62 may further include a mounting plate 84, which may be integrally formed with other portions of the inner bracket 62, and/or later attached thereto. In some examples, the mounting plate 84 may include a bore region 86, which may be configured to support a bore 88. As illustrated, the bore 88 may be offset from the machine vertical axis 90, which may be perpendicular to the fore/aft axis 92 and/or a lateral axis 94. Furthermore, the bore 88 may extend in a perpendicular direction to the mounting plate 84, and/or at any other defined angle. The mounting plate 84 may also include a stop region 96, which may be configured to support a stop 98, which will be described in greater detail below.

The outer bracket 64 may include an attachment plate 100 that is operably coupled with a base 102. In some instances, the base 102 can include a pair of walls 104, 106. The outer bracket 64 may further include an upper plate 108 and a lower plate 110 that may extend laterally inboard of the base 102. The upper plate 108 may define a first opening 112 and the lower plate 110 may define a second opening 114. The hinge pin 66 may be retained within each of the first opening 112 and the second opening 114 with fasteners 116, and/or through any other practical device or method. The bore 88 may be positioned about the hinge pin 66 and guide rotation of the breakaway boom section 42 when the breakaway boom section 42 is rotated relative to the outer boom section 40. In some cases, a tilt angle defined between the inner boom section 40 and the breakaway boom section 42 is varied as the breakaway boom section 42 rotates relative to the inner boom section 40.

In some cases, the lower plate may include one or more fins 118 that extend fore and/or aft of the hinge pin 66. The fins 118 may be configured to prevent further rotation of the breakaway boom section 42 by contacting the mounting plate 84, and/or any other component, when the breakaway boom section 42 is rotated to a defined angle. In some examples, the mounting plate 84 may include corresponding wings 120 that extend fore and/or aft of the bore 88 that are configured to interact with the fins 118.

A second hinge joint 122 may be operably coupled with the inner bracket 62 and the outer bracket 64 and define a second movement axis 124. The second movement axis 124 may be fore or aft of the pivot axis 58. In some cases, the inner bracket 62 may be operably coupled with a rotation member 126, and the outer bracket 64 may include a projection 128 that may be coupled to the rotation member 126. The inner bracket 62 may further include a guide 130 that may further support the protection as the breakaway boom section 42 moves between various positions. Additionally or alternatively, in some examples, the outer bracket 64 and/or the inner bracket 62 can include bumper 132 or other contact device. When the breakaway boom section 42 is in a first, default position, the bumper 132 may be positioned at a first distance from the outer bracket 64 and/or the inner bracket 62 (the first distance is between the bracket that the bumper 132 is not connected with and the bumper 132). When the breakaway boom section 42 is in a section position, the bumper 132 may separate from the outer bracket 64 and/or the inner bracket 62 and may be positioned at a second distance from the outer bracket 64 and/or the inner bracket 62 (the second distance is between the bracket that the bumper 132 is not connected with and the bumper 132). In various examples, the first distance may be less than the second distance.

With further reference to FIGS. 4-8, in various instances, at least a portion of the inner bracket 62 is positioned above the damper system 60. A damper 61 within the damper system 60 may be configured to control the force and the speed at which the damper 61 resists movement of the breakaway boom section 42 and/or moves the breakaway boom section 42 to a default position once the breakaway boom section 42 is deflected. As shown, in some examples, the damper 61 may be at least partially below the inner bracket 62.

As shown, in some examples, a latch member 134 may be rotatably coupled with the inner bracket 62. The latch member 134 may include a pair of latch member walls 136, 138, one or more connection structures 140, and a plurality of pins 142 operably coupled with the latch member walls 136, 138. For example, the latch member 134 may be rotatably coupled with the inner bracket 62 at a first damper joint 144. The damper 61 may also be coupled with the inner bracket 62, at a second damper joint 146. Moreover, an opposing end portion of the damper 61 may be operably coupled with the latch member 134 at a third damper joint 148.

As shown, in some examples, a linkage 150 may be operably coupled with the latch member 134 on a first end portion thereof and the outer bracket 64 on a second end portion thereof. In some cases, the coupling of the linkage 150 with the latch member 134 may form a fourth damper joint 152. Further, the coupling of the linkage 150 with the outer bracket 64 may form a fifth damper joint 154. In some cases, the fifth damper joint 154 may be positioned at least partially below the first damper joint 144, the second damper joint 146, and/or the fourth damper joint 152.

In various examples, the linkage 150 may be of an adjustable width or fixed length. Moreover, in some instances, the linkage 150 may be positioned at least partially vertically below at least a portion of the inner bracket 62. Additionally or alternatively, a center point 156 of the linkage 150 may be positioned at least partially laterally outboard of the hinge pin 66 relative to a frame 32 of the boom assembly 28.

In several examples, the damper 61 may correspond to a suitable hydraulic actuator. In such examples, the damper 61 may include both a cylinder 158 configured to house a piston 160 and a rod 162 coupled to the piston 160 that extends from the cylinder 158. Additionally, the damper 61 may include a piston-side chamber 164 and a rod-side chamber 166 defined within the cylinder 158. As is generally understood, by regulating the pressure of the fluid supplied to one or both of the cylinder chambers 164, 166, the actuation of the rod 162 may be controlled. As shown in FIGS. 4-8, the end portion of the rod 162 can be coupled to the latch member 134 at the third damper joint 148, while the cylinder 158 may be pivotably coupled to the inner bracket 62 at the second damper joint 146. However, the end portion of the rod 162 may be pivotably coupled to the inner bracket 62 while the cylinder 158 may be coupled to the latch member 134 without departing from the teachings provided herein. In various examples, a frame 46 of the inner boom section 40 and/or the inner bracket 62 may extend fore and/or aft of the damper 61. Additionally or alternatively, a frame 48 of the breakaway boom section 42 and/or the outer bracket 64 may extend fore and/or aft of the damper 61.

As provided herein, a stop 98 is supported by the stop region 96 of the mounting plate 84. In various examples, the latch member 134 may include a stop plate 168 that may be configured to interact with the stop 98. For example, when the stop plate 168 of the latch member 134 is rotated outboard, the stop 98 may define further rotation of the latch member 134 thereby defining a stop angle. Moreover, the stop 98 may be adjustable such that the stop angle may be altered by adjustment of the stop 98. In some instances, the adjustment of the stop 98 may be accomplished by altering a length of the stop 98 inboard of the mounting plate 84.

In some examples, the machine 10 may also include a hydraulic system 170 which provides a source of pressurized hydraulic fluid for driving and/or positioning the damper 61. In such examples, the hydraulic system 170 may be utilized to control the force and the speed at which the damper 61 resists movement of the breakaway boom section 42 and/or moves the breakaway boom section 42 to a default position once the breakaway boom section 42 is deflected. The position of the boom assembly 28 may be determined based on various operating conditions, user-defined preferences, and/or machine-learned methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update the boom deflection model. In some instances, the machine learning engine may allow for changes to the hydraulic pressure within the damper system 60 to be performed without human intervention.

In various examples, a computing system 172 may be communicatively coupled to the hydraulic system 170 and/or the damper 61. In general, the computing system 172 may include any suitable processor-based device, such as a computing device or any suitable combination of computing devices. Thus, in several examples, the computing system 172 may include one or more processors and associated memory configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory of the computing system 172 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory may generally be configured to store suitable computer-readable instructions that, when implemented by the processors, configure the computing system 172 to perform various computer-implemented functions, such as one or more aspects of the data processing algorithm(s) and/or related method(s) described below. In addition, the computing system 172 may also include various other suitable components, such as a communications circuit or module, one or more input/output channels, a data/control bus, and/or the like.

In several examples, the computing system 172 may correspond to an existing controller of the agricultural machine 10, or the computing system 172 may correspond to one or more separate processing devices. For instance, in some examples, the computing system 172 may form all or part of a separate plug-in module or computing device(s) that is installed relative to the machine 10 or the boom assembly 28 to allow for the disclosed agricultural system and method to be implemented without requiring additional software to be uploaded onto existing control devices of the machine 10 or the boom assembly 28.

In various examples, the computing system 172 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system 172 and may be used to generate a predictive evaluation of the alterations to the damper system 60. For instance, the computing system 172 may be configured to alter a default position of the piston 160 relative to the cylinder 158 based on various conditions.

In some examples, a sensor system 174 may be operably coupled with the boom assembly 28 and configured to generate data indicative of an operating condition of the machine, a condition of the field, an environmental condition, and/or any other condition. In various examples, the sensor system 174 may generate the data through one or more sensors 176 that may be mounted along the boom assembly 28. For instance, one or more sensors 176 may be mounted on the inner boom section 40, and/or one or more sensors 176 may be mounted on the breakaway boom section 42. One or more sensors 176 may be mounted on any other portion of the boom assembly 28 and/or the machine 10 as well without departing from the scope of the present disclosure.

In some cases, the sensor system 174 may further include one or more sensor brackets for retaining the sensors 176 in a position that is offset from a frame 44, 46, 48 of a boom section 38, 40, 42. For example, an inner section sensor bracket 178 may be operably coupled with the inner boom section 40. In some cases, the inner section sensor bracket 178 may be positioned at least partially below the inner bracket 62. As illustrated a first sensor 176 and/or a second sensor 176 may be operably coupled with the inner section sensor bracket 178. As shown, the first sensor 176 and/or the second sensor 176 may be positioned at least partially below the latch member 134, the linkage 150, an upper portion of the inner bracket 62, an upper portion of the outer bracket 64, and/or any other component. Additionally or alternatively, a breakaway section sensor bracket 180 may be operably coupled with the outer bracket 64. In some cases, the breakaway section sensor bracket 180 may be positioned at least partially above the outer bracket 64. As illustrated a first sensor 176 and/or a second sensor 176 may be operably coupled with the breakaway section sensor bracket 180. In various instances, the first sensor 176 and/or the second sensor 176 may be positioned at least partially above the outer bracket 64, the linkage 150, the latch member 134, the inner bracket 62, and/or any other component.

In some examples, the breakaway boom section 42 may include a protector 182 that is disposed fore of a frame 48 of the boom breakaway section. The protector 182 may be configured to contact an object before other components of the breakaway boom section 42 thereby protecting the one or more components that are aft of the protector 182. In some examples, the breakaway section sensor bracket 180, the first sensor 176, and/or the second sensor 176 may be positioned at least partially fore of the outer bracket 64 and/or the linkage 150 and aft of the protector 182. Further, in various examples, the protector 182 may be operably coupled with the outer bracket 64.

With further reference to FIGS. 4-8, a retainment assembly 184 may be operably coupled with the inner bracket 62 and/or the outer bracket 64. In various examples, the retainment assembly 184 may be configured to selectively retain one or more conduits 192 with one or more retainers 186. The retainers 186 may include one or more body segments 188 that collectively define one or more retainment openings 190. The conduits 192 may be selectively retained within the retainment openings 190. However, the retainment assembly 184 may additionally or alternatively include any other device for selectively retaining the conduits 192. The conduits 192 may be configured as hoses for guiding the agricultural product to one or more nozzle assemblies along the boom assembly 28. Additionally or alternatively, the conduits 192 may be configured to retain one or more cables, wires, or other devices that are configured to provide power, transmit data, and/or provide any other function for one or more components distributed along the boom assembly 28. In some instances, the retainment assembly 184 may be configured to selectively route one or more conduits 192 vertically above at least a portion of the damper system 60. Additionally or alternatively, the retainment assembly 184 can retain the one or more conduits 192 at least partially above the damper system 60 as the breakaway boom section 42 is rotated relative to the inner boom section 40. As such, the conduits 192 may be generally free from contact with the hinge assembly 56 and/or the damper system as the breakaway boom section 42 is rotated relative to the inner boom section 40.

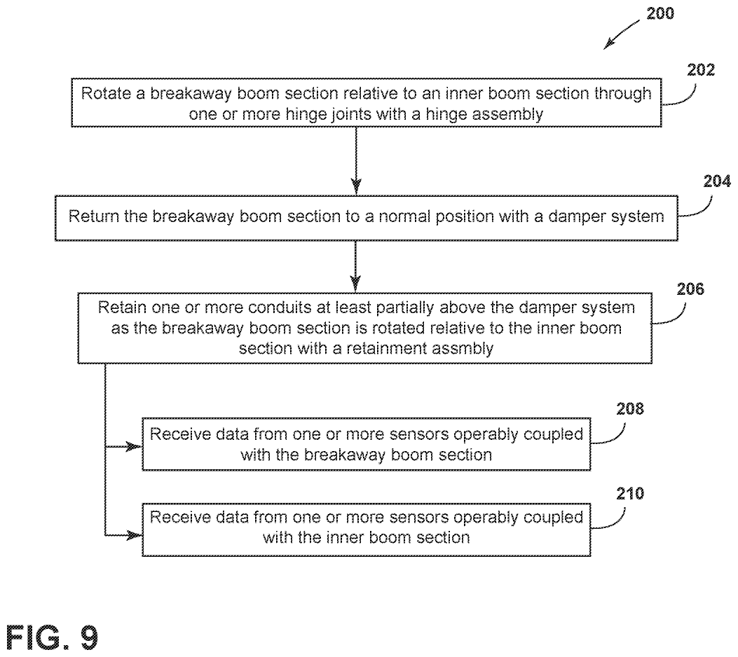

Referring now to FIG. 9, a flow diagram of some embodiments of a method 200 for an agricultural application operation is illustrated in accordance with aspects of the present subject matter. In general, the method 200 will be described herein with reference to the machine 10 described above with reference to FIGS. 1-8. However, the disclosed method 200 may generally be utilized with any suitable agricultural machine 10 and/or may be utilized in connection with a system having any other suitable system configuration. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in various ways without deviating from the scope of the present disclosure.

As illustrated in FIG. 9, at (202), the method may include rotating a breakaway boom section relative to an inner boom section through one or more hinge joints with a hinge assembly.

At (204), the method may include returning the breakaway boom section to a default position with a damper system. In various examples, a hydraulic pressure within the damper system may be varied to control the force or the speed at which the damper resists movement of the breakaway boom section. The position of the boom assembly may be determined based on various operating conditions, user-defined preferences, and/or machine-learned methods and algorithms that utilize one or several machine learning techniques including, for example, decision tree learning, including, for example, random forest or conditional inference trees methods, neural networks, support vector machines, clustering, and Bayesian networks. These algorithms may include computer-executable code that may be retrieved by the computing system and/or through a network/cloud and may be used to evaluate and update the boom deflection model. In some instances, the machine learning engine may allow for changes to the hydraulic pressure within the damper system to be performed without human intervention.

At step (206), the method 200 may include retaining one or more conduits at least partially above the damper system as the breakaway boom section is rotated relative to the inner boom section with a retainment assembly. In various examples, the retainment assembly may be configured to selectively retain one or more conduits with one or more retainers. The retainers may include one or more body segments that collectively define a retainment opening. The conduits may be selectively retained within the retainment openings. However, the retainment assembly may additionally or alternatively include any other device for selectively retaining the conduits. The conduits may be configured as hoses for guiding the agricultural product to one or more nozzle assemblies along the boom assembly. Additionally or alternatively, the conduits may be configured to retain one or more cables, wires, or other devices that are configured to provide power, transmit data, and/or provide any other function for one or more components distributed along the boom assembly.

In some instances, the method 200, at step (208), may include receiving data from one or more sensors operably coupled with the breakaway boom section. In some instances, the data may be generated as the breakaway boom section is rotated relative to the inner boom section. Additionally or alternatively, the method 200, at step (208), may include receiving data from one or more sensors operably coupled with the inner boom section. In some cases, the one or more sensors operably coupled with the inner boom section may be positioned at least laterally outboard of an inner bracket operably coupled with the inner boom section and supporting the breakaway boom section.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a boom assembly including an inner boom section having an inner section frame and a breakaway boom section having a breakaway section frame;
a hinge assembly configured to guide movement of the breakaway boom section relative to the inner boom section, the hinge assembly comprising:
an inner bracket operably coupled with the inner boom section and a mounting plate;
an outer bracket operably coupled with the breakaway section frame;
a hinge pin operably coupled with the outer bracket; and
a bore operably coupled with the mounting plate and surrounding the hinge pin; and
a damper system operably coupled with the inner bracket and the outer bracket, wherein at least a portion of the inner bracket is positioned above the damper system.

2. The system of claim 1, wherein the damper system further comprises:
a latch member rotatably coupled with the inner bracket at a first damper joint.

3. The system of claim 2, wherein the damper system further comprises:
a damper operably coupled with the inner bracket at a second damper joint and with the latch member at a third damper joint.

4. The system of claim 3, wherein the damper system further comprises:
a linkage operably coupled with the latch member at a fourth damper joint and the outer bracket at a fifth damper joint, the linkage positioned vertically below at least a portion of the inner bracket.

5. The system of claim 4, wherein a center point of the linkage is positioned laterally outboard of the hinge pin relative to a frame of the boom assembly.

6. The system of claim 1, further comprising:
a retainment assembly operably coupled with the inner bracket, the retainment assembly configured to selectively retain a conduit.

7. The system of claim 1, further comprising:
an inner section sensor bracket operably coupled with the inner boom section, the inner section sensor bracket positioned at least partially below the inner bracket.

8. The system of claim 7, further comprising:
a sensor operably coupled with the inner section sensor bracket, the sensor positioned at least partially below a latch member.

9. The system of claim 1, further comprising:
a breakaway section sensor bracket operably coupled with the outer bracket, the breakaway section sensor bracket positioned at least partially above the outer bracket.

10. The system of claim 9, further comprising:
a sensor operably coupled with the breakaway section sensor bracket, the sensor positioned at least partially above the outer bracket.

11. The system of claim 1, wherein a tilt angle defined between the inner boom section and the breakaway boom section is configured to be varied as the breakaway boom section rotates relative to the inner boom section.

12. A method for an agricultural application operation, the method comprising:
rotating, with a hinge assembly, a breakaway boom section relative to an inner boom section through one or more hinge joints;
returning, with a damper system, the breakaway boom section to a default position; and
retaining, with a retainment assembly, one or more conduits at least partially above the damper system as the breakaway boom section is rotated relative to the inner boom section.

13. The method of claim 12, further comprising:
receiving data from one or more sensors operably coupled with the breakaway boom section as the breakaway boom section is rotated relative to the inner boom section.

14. The method of claim 12, further comprising:
receiving data from one or more sensors operably coupled with the inner boom section, the one or more sensors operably coupled with the inner boom section positioned at least laterally outboard of an inner bracket operably coupled with the inner boom section and supporting the breakaway boom section.

15. The method of claim 12, wherein a hydraulic pressure within the damper system is varied to control a force or a speed at which the damper resists movement of the breakaway boom section.

16. An agricultural system comprising:
a boom assembly including an inner boom section and a breakaway boom section;
a hinge assembly configured to guide movement of the breakaway boom section relative to the inner boom section;
a damper system operably coupled with the inner boom section and the breakaway boom section; and
a retainment assembly configured to route one or more conduits vertically above at least a portion of the damper system.

17. The agricultural system of claim 16, wherein the hinge assembly further comprises:
an inner bracket operably coupled with the inner boom section; and
an outer bracket operably coupled with the breakaway boom section.

18. The system of claim 17, further comprising:
an inner section sensor bracket operably coupled with the inner boom section, the inner section sensor bracket positioned at least partially below the inner bracket.

19. The system of claim 18, further comprising:
a sensor operably coupled with the inner section sensor bracket, the sensor positioned at least partially below the breakaway section bracket.

20. The system of claim 17, further comprising:
a breakaway section sensor bracket operably coupled with the outer bracket, the breakaway section sensor bracket positioned at least partially above the outer bracket; and
a sensor operably coupled with the breakaway section sensor bracket, the sensor positioned at least partially above the outer bracket.
